(19) United States
(12) Patent Application Publication
(10) Pub. No.: US 2009/0281943 A1
(43) Pub. Date: Nov. 12, 2009

(54) Systems and Methods for Collecting Bonds and Fines for Warrants and Traffic Tickets

(76) Inventor: A. John YOGGERST, San Antonio, TX (US)

Correspondence Address: KAMMER BROWNING PLLC, 7700 BROADWAY, SUITE 202, SAN ANTONIO, TX, 78209, US

(21) Appl. No.: 12/435,898

(22) Filed: May 5, 2009

Related U.S. Application Data
(60) Provisional application No. 61/051,312, filed on May 7, 2008.

(51) Int. Cl. G06Q 20/00

(52) U.S. Cl. 705/39

(57) ABSTRACT

Systems and methods are provided that allow law officers to carry out financial transactions with individuals having outstanding warrants who might otherwise be arrested. The system includes a wireless (typically cellular based) credit card/debit card transaction unit carried by the law officer during the process of serving the warrant, or during a traffic stop, wherein an outstanding warrant is identified. The system further includes a wide area network (Internet) connection that facilitates record keeping functionality associated with the posting of the bond or payment of the fine by the individual being addressed by the law officer. The appropriate financial transaction computer systems convey payment or posting of the bond to a database associated with the police station or the like. Likewise, wide area network (Internet) connections to databases associated with the judicial courts that may have issued the warrants are also secured for the purposes of verifying the posting of the bond or the payment of the fine. The real time updating of records in each of the various agency databases provides the necessary security for both the individual on whom the warrant is served, and for the agencies involved in executing the warrant.

### CROSS REFERENCES TO RELATED APPLICATIONS

This application claims the benefit under Title 35 United States Code §119(e) of U.S. Provisional Application 61/051,312 filed May 7, 2008 the full disclosure of which is incorporated herein by reference.

### BACKGROUND OF THE INVENTION

1. Field of the Invention

The present invention relates generally to systems and methods for collecting bonds or fines associated with outstanding judicial warrants. The present invention relates more specifically to systems and methods for implementing a financial transaction to collect a bond or fine on an outstanding warrant or other legal violation by a law officer in the field via a wireless terminal.

2. Description of the Related Art

There are a number of situations wherein judicial warrants are issued for individuals that have failed to appear in court or have failed to pay a fine according to the terms of an issued ticket, court order, or other citation. As an example, if a driver receives a traffic citation and fails to pay the fine or appear in court by the date indicated on the ticket, normally a warrant is issued for that driver's arrest. Likewise, when a party fails to appear or does not otherwise comply with a judicial court's orders, a warrant may be issued for that individual's arrest. Such warrants are issued thousands of times each day in municipalities and legal jurisdictions across the country.

There are generally two mechanisms whereby individuals may be forced to pay fines or provide bonds for violations, both of which involve the time of an arresting officer. Law officers may be directed to go to the residence or business of the individual with an outstanding warrant and arrest the individual, or an outstanding warrant may become apparent during a routine traffic stop and the law officer must decide whether to serve the outstanding warrant on the individual. Both of these mechanisms for serving warrants and collecting bonds and/or fines are time consuming, both for the law officer and for the court systems involved. In many traffic stop instances, even where an outstanding warrant is identified, a law officer may choose to provide the individual additional time to appear in municipal court rather than take such time consuming steps as are necessary to arrest the individual at the time of the traffic stop.

In the case of a warrant being personally served at a residence or business, the arresting officer is seldom in a position to be able to receive the amount of the fine or the bond even if the individual is financially able to post such a bond or pay a fine. In almost every case, the officer expects to arrest the individual on whom the warrant is being served. The arrest includes transportation of the individual to the police station or other booking facility where the individual is booked and then provided the opportunity to pay the fine or post the bond. In general, only the booking facility is set up to receive and carry out the financial transaction associated with the payment of the fine or the posting of the bond.

For outstanding warrants that come to light during routine traffic stops and the like, the officer making the traffic stop will typically verify by way of a radio link or other wireless connection, the existence of any outstanding warrants for the individual that has been stopped. If there is an outstanding warrant, the information is generally available to the officer such that the officer must make a decision to arrest the individual or simply issue a new citation for the violation that prompted the traffic stop. Here as well it is generally not possible for the officer to accept any payment of the outstanding fine or to receive the bond amount for the outstanding warrant. The alternative is therefore to either allow the individual to go or to arrest the individual and transport them to a booking facility. An added complication associated with traffic stops is the requirement that the individual's vehicle be impounded and stored. Only after transportation of the individual to the booking facility are systems available for receiving the financial transaction associated with the posting of a bond or the payment of a fine.

It would be desirable if a system and method were available whereby a law officer seeking to serve a warrant on an individual at their residence or business, or a law officer faced with an outstanding warrant identified at a routine traffic stop, would be capable of implementing a financial transaction with the individual that amounted to the posting of the bond or the payment of the fine. It would be desirable if such a system could operate in conjunction with any of a number of available credit or debit cards that many individuals currently carry. It would be important for such a system to provide immediate verification of the capacity of the individual to engage in the financial transaction with the particular credit card or debit card. It would be important for the system to provide an immediate written record of the financial transaction for both the law officer's sake and for the individual paying the fine or posting the bond.

### SUMMARY OF THE INVENTION

It is therefore the object of the present invention to provide systems and methods that allow law officers to carry out a financial transaction with individuals who might otherwise be arrested on outstanding warrants. The system of the present invention includes a wireless (typically cellular based) credit/debit card transaction unit carried by the law officer during the process of serving the warrant or during a traffic stop wherein an outstanding warrant is identified. The system further includes a wide area network connection that facilitates record keeping functionality associated with the posting of the bond or payment of the fine by the individual being addressed by the law officer. The appropriate financial transaction computer systems convey payment or posting of the bond to a database associated with the police station or law officer's base. Likewise, wide area network connections to databases associated with the judicial courts that may have issued the warrants are also secured for the purposes of verifying the posting of the bond or the payment of the fine. The real time updating of records in each of the various agency databases provides the necessary security for both the individual on whom the warrant is served, and for the agencies involved in executing the warrant.

The methods involved are initially similar in some respects to ordinary financial transactions associated with credit and/or debit cards. The unique use of the wireless credit/debit card system by the law officer allows the transaction to occur in the field as opposed to at the booking facility or police station. Carrying out the transaction in the field allows the law officer to release the individual and their vehicle (if the warrant is being served during a traffic stop) and thereby reduce the time involved for both the officer and the individual.

Many states have legislation that allows the various municipalities to add a collection fee to outstanding traffic warrants in addition to the initial fine and warrant fee. This would allow a means for recovering the costs associated with implementing the system of the present invention. The system of the present invention would create and maintain a database linking the police department records and the jurisdictional court records to process the arrested parties with the financial transaction that will occur. The portable credit card/debit card reader/printer units may be distributed to the various police substations that would allow each patrol officer to take a unit into the field when they initiate their daily patrol. The jurisdictional court system would receive the bond amount equal to the initial fine plus any court costs and warrant fees that were imposed. System costs would be covered by the permitted collection fee associated with the warrant collection where such has been authorized by law. Where such collection fees are not authorized, the system would still be advantageous in its manner of reducing the time and therefore the costs associated with serving a warrant and arresting the individuals as described above.

A typical scenario involved in a traffic stop would have the officer offer the individual the choice of having his auto impounded and going to jail or posting a bond equal to the outstanding warrant and ticket plus the collection fee. This financial transaction would be made available to the individual through a credit or debit card. The individual would receive a printed receipt stating which ticket or tickets had been bonded. The party would still, of course, have to appear for any violations for which the individual was then being cited with the ticket just bonded.

Advantages to the system of the present invention would include the jurisdictional court system receiving its funds for the bond equal to the outstanding ticket and warrant in as little as twenty-four hours. It is likely that the municipal court system would be able to collect fines and bonds from individuals who might otherwise not have been arrested during a traffic stop due to a time constraints placed upon the law officer. The arresting officer would not have to wait to impound the individual's vehicle, would not have to transport the individual to the jurisdictional court or the booking facility.

In addition, the individuals operating the booking facility would have one less party to process, thus reducing the costs associated with operating the booking facility. The individual would not have to appear before the jurisdictional magistrate for booking thereby saving the magistrate's time for the warrant being served. Because no data is being stored in the handheld device that the officer utilizes to carry out the financial transaction, there is no concern for legal security relating to the warrant information in the device itself. The information continues to reside only in the existing databases of the court system and the police records. For the individual that might otherwise be arrested, there are, of course, a number of advantages as well. The system and method of the present invention save the individual the embarrassment of having to contact someone to bail them out of jail and post bond at the booking facility. They save the individual the cost of transportation to the impound facility after being released and saves the wrecker and impound charges associated with impounding the vehicle. Other advantages of the systems and methods of the present invention will become apparent to those skilled in the art after a review of the attached drawings and a reading of the following detailed description of the same.

### BRIEF DESCRIPTION OF THE DRAWINGS

FIG. 1 is a partially schematic block diagram showing the various functional hardware components of the system of the present invention.

FIG. 2 is a flow chart showing the basic methodology of existing systems (prior art) and the manner in which the method of the present invention interfaces with the existing procedures.

FIG. 3 is a continuation of the flow chart shown in FIG. 2 identifying the various steps of the methodology of the present invention.

### DETAILED DESCRIPTION OF THE PREFERRED EMBODIMENTS

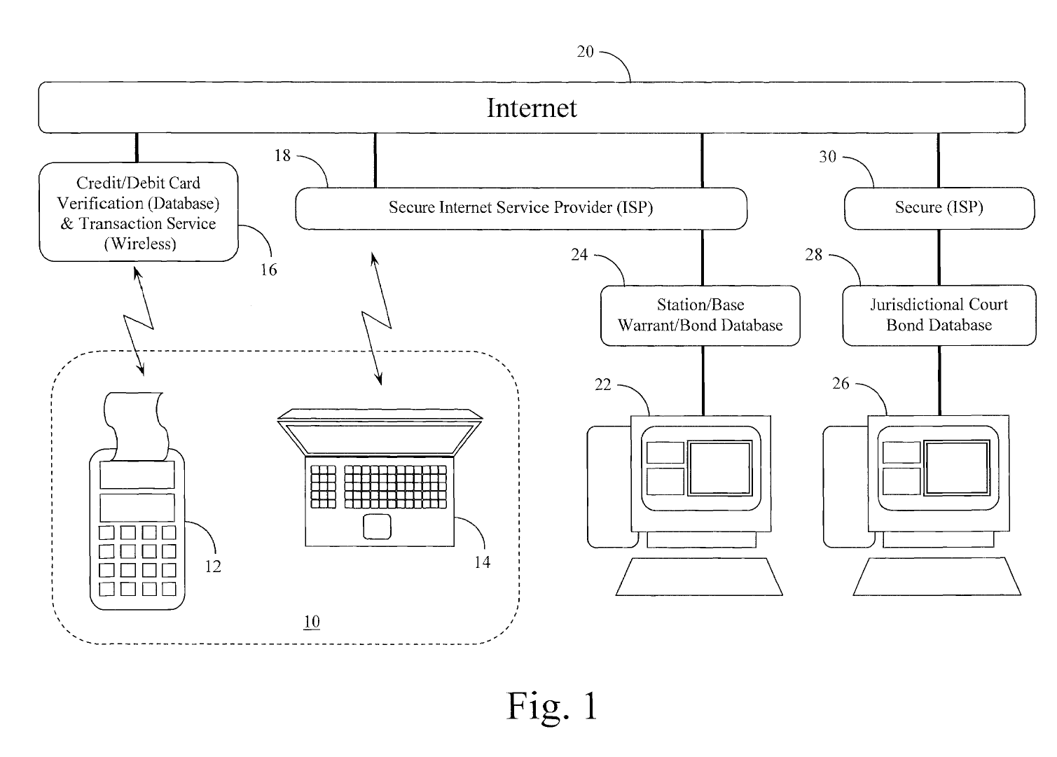

Reference is made first to FIG. 1 for a brief description of the hardware components associated with the system of the present invention. It is understood that the components shown in FIG. 1 are provided by way of example only and do not necessarily define the specific electronics or the communications channels required to carry out the method of the present invention. The components identified in FIG. 1 therefore are basic representations of the types of components required to carry out the system but are not necessarily limiting as to the precise structure of the data communications systems involved.

The law officer involved in serving a warrant (either directly or as a result of an incidental traffic stop) will have in their possession the necessary electronics communications components 10 required to carry out the methodology of the present invention. The basic components for this purpose include the credit/debit card transaction device 12 and a computer based data communication device 14, which in the preferred embodiment is typically a laptop computer positioned within the officer's vehicle. The combination of these two data communication devices allow the office to carry out the methodology of the present invention. Credit/debit card device 12 may be any of a number of different wireless credit card transaction devices currently available on the market. These devices allow the entry of numerical information by way of swiping a credit card or a debit card through a card reader on the device and/or the entry of numerical information on a keypad. Such credit/debit card devices typically further include thermal printer components that allow a printed record of the transaction to be immediately provided. These devices typically communicate by means of cellular phone system through the data networks associated therewith. Typically the device contacts or calls a specific phone number through which data communication is established. In the present invention this phone number is associated with the credit/debit verification (database) and transaction service 16.

The computer based data communication system 14 that the law officer carries with them is likewise in wireless communication with what is typically a secure internet service provider (ISP) 18 which provides access to the Internet 20 and thereby back to a station/base warrant/bond database 24. It is through this database 24 that the office may check with the computer system 22 located at his or her station or base to verify the existence of the outstanding warrant.

A similar database in provided through the judicial court bond database 28 which is likewise connected through a secure internet service provider (ISP) 30 to the Internet 20 for receiving appropriate verification of the bond payment and the financial transaction involved. All of the information associated with the posting of the bond and the financial transaction would be made available to the jurisdictional court computer system 26 as well as the police station computer system 22. Normal secure transaction protocols would be implemented in carrying out not only the financial transaction but the reporting features of the system of the present invention in order to maintain the necessary privacy and confidentiality associated with the financial transaction and the warrant execution.

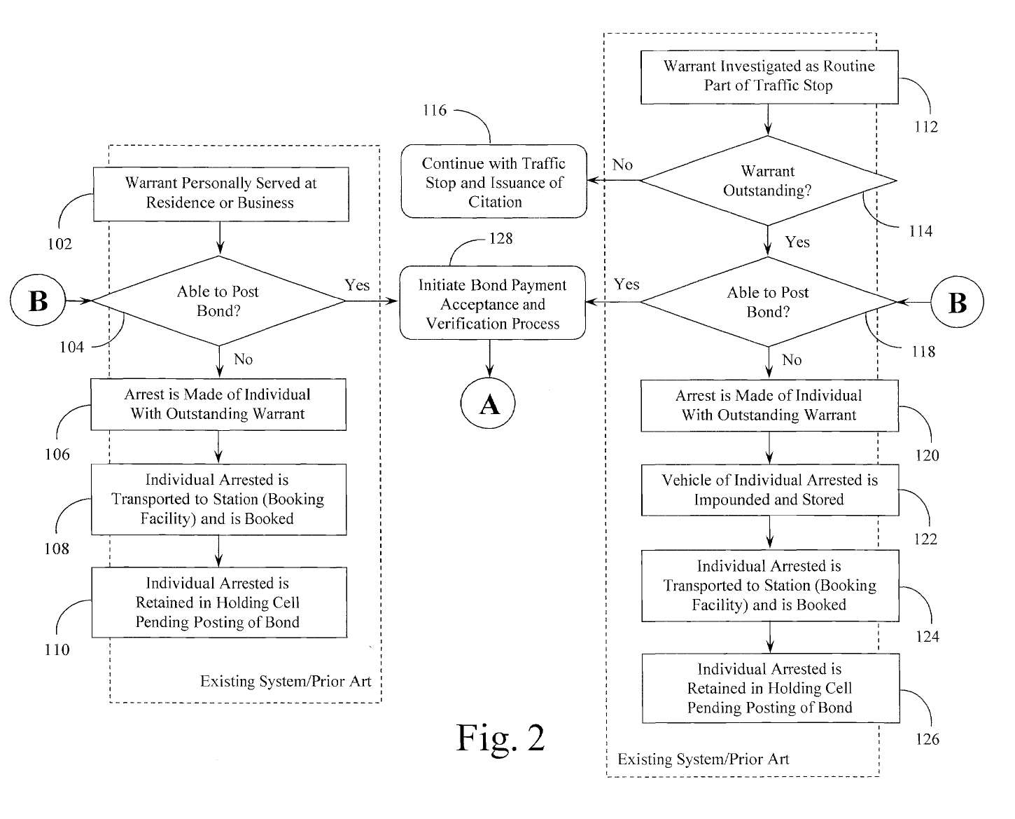

Reference is now made to FIG. 2 for a brief description of the existing methods that the present invention is intended to supplement and partially replace. FIG. 2 shows the two basic procedures whereby a warrant is served on an individual either by directing such service specifically to the individual, or as a result of a routine traffic stop. Step 102 in FIG. 2 represents the first step in the process whereby a warrant is being personally served on an individual at a residence or business, and whereby an arresting officer locates and identifies the individual for whom the outstanding warrant exists. It is determined at Step 104 whether the individual is able to post the bond. If not, then at Step 106 an arrest is made of the individual with the outstanding warrant by the arresting officer. At Step 108 the individual arrested is transported to the police station or other booking facility and is put through the booking process. Typically the booking process involves, at Step 110, the individual arrested being retained in a holding cell pending the posting of a bond by a third part or bonding agency that the individual has contacted. Standard systems are available at the booking facility to receive and carry out the financial transaction associated with the posting of the bond.

Step 112 in FIG. 2 represents the first step in the situation where an outstanding warrant is identified as part of a routine traffic stop made by the law officer. At Step 114 the law officer determines whether there is an outstanding warrant on the individual that has been stopped. If not, then the law officer continues at Step 116 with the traffic stop and the issuance of a new citation. If there is a warrant outstanding as determined at Step 114, the law officer determines if the individual is able to post bond at Step 118. If not, an arrest is made of the individual with the outstanding warrant at Step 120. At Step 122 the individual's vehicle is impounded and stored. The individual arrested is transported to the station or other booking facility and is processed through the booking procedure at Step 124. Finally, the individual arrested is retained in a holding cell at the station or booking facility pending the posting of a bond by a third party or bonding agency at Step 126.

If in either of the above described two scenarios the individual is able to post bond (at Step 104 or Step 118 as described above) then the process proceeds to Step 128 wherein the law officer initiates the bond or fine payment, acceptance, and verification process.

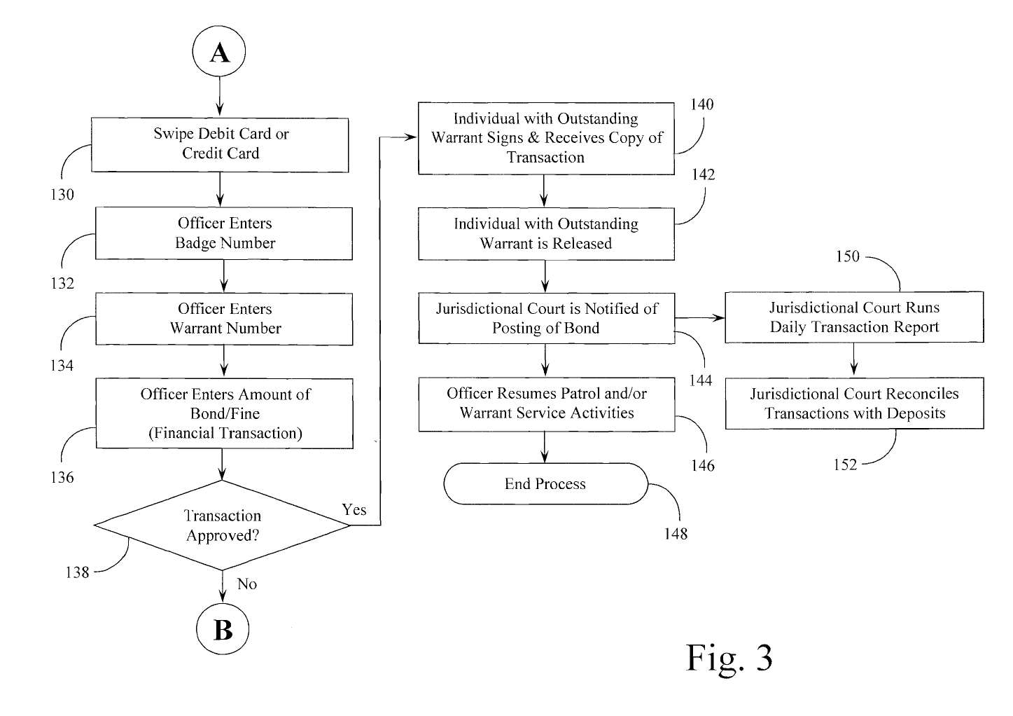

This bond payment, acceptance, and verification process continues as shown in FIG. 3. The law officer swipes the debit card or credit card at Step 130. The law officer then enters his or her badge number at Step 132 as a means for identifying and later confirming the financial transaction being carried out. Then at Step 134 the law officer enters the warrant number which has either been provided previously at the officer's base of operation or is provided by means of the computer data communication system (laptop computer) that the officer possesses in his vehicle. At Step 136 the officer enters the amount of the bond or fine and initiates the financial transaction. At Step 138, after communication occurs from the wireless credit/debit card device, the transaction is either approved or disapproved. If approved, the individual with the outstanding warrant signs and receives a copy of the transaction at Step 140. Step 142 then provides for the individual with the outstanding warrant to be released. At Step 144 the jurisdictional court is notified of the posting of the bond by means of the database communications described above with respect to FIG. 1. The officer resumes patrol and/or warrant service activities at Step 146 and the process of the present invention carried out by the law officer ends at Step 148.

In the process of the jurisdictional court being notified of the posting of the bond, the jurisdiction court runs a daily transaction report at Step 150. This jurisdictional court record reconciles the transactions with the deposits that are being made as a result of the financial transactions at Step 152. In this manner, both the clearing of the warrant from the respective databases and the correlation of that information with the receipt of funds into the jurisdictional courts bank accounts is made and confirmed.

Although the present invention has been described in terms of the foregoing embodiments, this description has been provided by way of explanation only and is not intended to be construed as a limitation of the invention. Those skilled in the art will recognize modifications to the present invention that might accommodate the specific data communication environments within which the method is carried out. As indicated above, the various data communication devices of all of the systems of the present invention may be simpler or more complex than those described in the preferred embodiment. The basic communication of data as indicated in the above description provides the fundamental requirements for carrying out the methodology of the present invention. Modifications to the number and location of the various databases involved are also anticipated and will be apparent to those skilled in the art. These modifications do not necessarily depart from the spirit and scope of the methodology of the present invention.

I claim:

1. A system to allow law enforcement officers to carry out financial transactions with individuals having outstanding warrants who might otherwise be arrested, the system comprising:
a wireless credit card/debit card transaction unit carried by the law officer during the process of serving a warrant or during a traffic stop wherein an outstanding warrant is identified;
a first wide area data communication network connection to facilitate record keeping functionality associated with the posting of the bond or payment of the fine by the individual being addressed by the law officer;
at least one financial transaction computer system having a stored database, the computer system to convey payment or posting of the bond to the database; and
a second wide area data communication network connection to a remote database associated with the judicial courts that issued the warrant for verifying the posting of the bond or the payment of the fine.

2. A method for law enforcement officers to carry out financial transactions with individuals having outstanding warrants who might otherwise be arrested, the method comprising the steps of:
providing a wireless credit card/debit card transaction unit to the law officer, the law officer carrying the unit during the process of serving a warrant or during a traffic stop wherein an outstanding warrant is identified;
accessing a first wide area data communication network connection to record the posting of the bond or payment of the fine by the individual being addressed by the law officer;
accessing at least one financial transaction computer system having a stored database and conveying information on the payment or posting of the bond to the stored database;
accessing a second wide area data communication network connection to a remote database associated with the judicial courts that issued the warrant and verifying the posting of the bond or the payment of the fine; and
updating records in each of the various agency databases and providing the necessary data security for both the individual on whom the warrant is served, and for the agencies involved in executing the warrant.
